(19) United States
(12) Patent Application Publication
(10) Pub. No.: US 2025/0383303 A1
(43) Pub. Date: Dec. 18, 2025

(54) METHOD AND SYSTEMS FOR ALIGNMENT OF ROCK SAMPLES

(71) Applicant: SAUDI ARABIAN OIL COMPANY, Dhahran (SA)

(72) Inventors: Sinan Caliskan, Dhahran (SA); Naif J. Alqahtani, Dammam (SA); Abdullah F. Dhneem, Saihat (SA); Faisal S. Dossary, Khobar (SA)

(73) Assignee: SAUDI ARABIAN OIL COMPANY, Dhahran (SA)

(21) Appl. No.: 18/746,707

(22) Filed: Jun. 18, 2024

(51) Int. Cl. G01N 23/046; E21B 49/06; G01N 23/083

(52) U.S. Cl. CPC G01N 23/046; G01N 23/083; E21B 49/06; G01N 2223/3303; G01N 2223/616

(57) ABSTRACT

Methods and systems are disclosed herein. A method includes disposing a rock sample in a rock sample housing comprising a first end and a second end. The method includes placing the rock sample housing within a scanner. The method includes translating a sliding main table along a sliding main rail having a length of travel to locate the first end at a first stopping point along the length of travel. The method includes positioning, using a plurality of alignment apparatuses, the first end within a gantry of the scanner along a first planar orientation. The method includes translating the sliding main table along the sliding main rail to locate the second end at a second stopping point along the length of travel. The method includes positioning, using the plurality of alignment apparatuses, the second end within the gantry along the first planar orientation.

### BACKGROUND

Forecasting hydrocarbon production requires an understanding of rock properties of a hydrocarbon reservoir to be able to accurately predict hydrocarbon flow through the hydrocarbon reservoir. Understanding hydrocarbon flow and reservoir behavior during production and extraction of the hydrocarbons from a subsurface hydrocarbon reservoir is useful for maximizing recovery of hydrocarbons. Coring is done to extract cores from the subsurface to sample the rock in the depth intervals of interest.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In some aspects, the techniques described herein relate to a method for aligning rock samples in a scanner, the method includes disposing a rock sample in a rock sample housing configured to receive the rock sample, wherein the rock sample housing includes a first end and a second end. The method may include placing, using a clamp system, the rock sample housing within the scanner. The method may include translating, using a scanner control system, a sliding main table along a sliding main rail having a length of travel to locate the first end at a first stopping point along the length of travel. The clamp system is operatively connected to the sliding main table and configured to translate with the sliding main table. The method may include positioning, using a plurality of alignment apparatuses, the first end of the rock sample housing within a gantry of the scanner along a first planar orientation. The method may include translating, using the scanner control system, the sliding main table along the sliding main rail to locate the second end at a second stopping point along the length of travel. The method may include positioning, using the plurality of alignment apparatuses, the second end of the rock sample housing within the gantry along the first planar orientation.

In some aspects, the techniques described herein relate to a system for aligning rock samples in a scanner, the system includes a rock sample, a rock sample housing, a scanner, a plurality of alignment apparatuses, and a scanner control system. The rock sample housing is configured to receive the rock sample. The rock sample housing includes a first end and a second end. The scanner includes a gantry configured to scan the rock sample, a sliding main rail having a length of travel, a sliding main table, and a clamp system. The sliding main table is configured to translate along the sliding main rail. The clamp system is operatively connected to the sliding main table. The clamp system is configured to receive the rock sample housing. The plurality of alignment apparatuses is configured to position the first end of the rock sample housing within the gantry along a first planar orientation and position the second end of the rock sample housing within the gantry along the first planar orientation. The scanner control system is configured to translate the sliding main table along the sliding main rail to locate the first end at a first stopping point along the length of travel and translate the sliding main table along the sliding main rail to locate the second end at a second stopping point along the length of travel.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 depicts a well environment having a coring system in accordance with one or more embodiments.

FIG. 2 shows a side view of a rock sample alignment system in accordance with one or more embodiments.

FIG. 3A shows a top view of a rock sample alignment in accordance with one or more embodiments.

FIG. 3B shows a side view of a rock sample housing in accordance with one or more embodiments.

FIG. 4 depicts a rock sample scanning system in accordance with one or more embodiments.

FIG. 5 shows a side view of a gantry within a rock sample alignment system in accordance with one or more embodiments.

FIG. 6A shows an alignment apparatus in accordance with one or more embodiments.

FIG. 6B shows an exploded view of an alignment apparatus in accordance with one or more embodiments.

FIG. 7 shows a schematic diagram of a computer system in accordance with one or more embodiments.

FIG. 8 shows a flowchart of a rock sample alignment method in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowchart may be omitted, repeated, and/or performed in a different order than the order shown. Accordingly, the scope disclosed herein should not be considered limited to the specific arrangement of steps shown in the flowchart.

Although multiple dependent claims are not introduced, it would be apparent to one of ordinary skill that the subject matter of the dependent claims of one or more embodiments may be combined with other dependent claims.

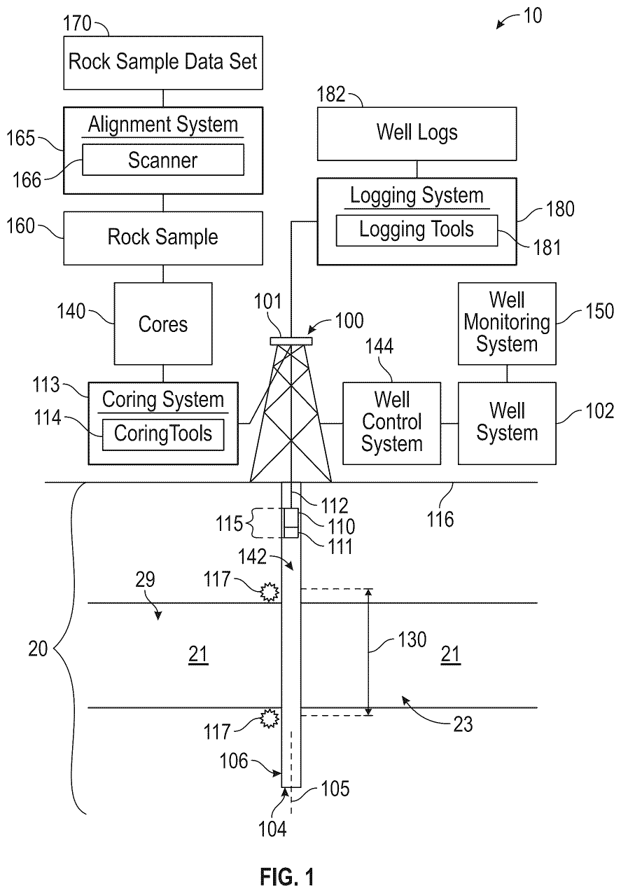

In the following description of FIGS. 1-8, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

Methods and systems for aligning rock samples in a rock sample scanner are disclosed herein. The method may include placing a rock sample in a rock sample housing. The rock sample housing may be placed in a clamp system configured to hold the rock sample housing. The clamp system may be operatively coupled to a sliding main table configured to translate along a sliding main rail. The sliding main table may be configured to stop at one or more stopping points. The rock sample scanner may include a gantry configured to scan rock samples and output a rock sample data set. The rock sample housing may be aligned within the gantry using a plurality of alignment apparatuses. The rock sample housing includes a first end and a second end. The sliding main table may translate so as to locate the first end at a first stopping point. The first end may be aligned within the gantry using the plurality of alignment apparatuses. The sliding main table may translate so as to locate the second end at a second stopping point. The second end may be aligned in the gantry using the plurality of alignment apparatuses. After alignment, the rock sample may be scanned to obtain a rock sample data set that includes at least one rock property.

FIG. 1 shows a schematic diagram of a well environment (10) that includes a well site (100) in accordance with one or more embodiments. The well environment (10) may include a subterranean region of interest (20) (hereafter “subsurface” (20)). The subsurface (20) includes one or more formations having a geologic boundary separating each formation. Each formation may include lithologies with varying rock properties such as porosity, permeability, density, and the like. The one or more formations may include faulting, fracturing, and/or dissolution that may span across the one or more formations. One of the one or more formations may include a reservoir formation (21), a source formation (not shown), and/or a cap rock (not shown). The reservoir formation (21) may include one or more rock properties (23) such as porosity and permeability suitable for storing formation fluids (29) such as gas, oil, and/or formation water.

The well environment (10) may include a well (101) having a borehole (104) extending into the subsurface (20). The well system (102) includes hardware and/or software for carrying out well operations such as flowlines, safety systems, pressure systems, drilling systems, and valve systems. The well system (102) is configured to complete well operations including drilling, appraisal, and/or production operations. The borehole (104) having a borehole central axis (105) includes a bored hole and a borehole wall (106). In some embodiments, the bored hole may extend from a surface of the earth (116) into a target zone of the reservoir formation (21). The one or more formations such as the reservoir formation (21) may include various formation characteristics of interest, such as formation porosity, formation permeability, resistivity, water saturation, and free water level (FWL). Porosity may indicate how much void space exists in a particular rock within an area of interest in the subsurface (20), where formation fluids (29) may be trapped. Permeability may indicate the ability of liquids and gases to flow through the rock within the area of interest. Resistivity may indicate how strongly rock or fluid within the subsurface (20) opposes the flow of electrical current. For example, resistivity may be indicative of the porosity of the subsurface (20) and the presence of hydrocarbons. More specifically, resistivity may be relatively low for a formation that has high porosity and a large amount of formation water, and resistivity may be relatively high for a formation that has low porosity or includes a large quantity of hydrocarbons such as oil and/or gas. Water saturation may indicate the fraction of formation water in a given pore space.

Keeping with FIG. 1, the well environment (10) may include a well control system (144), a drilling system, and/or a coring system (113). In some embodiments, the drilling system includes a drill string (112), a drill bit (111) and a mud circulation system for use in boring the borehole (104) into the subsurface (20). The well control system (144) may include hardware or software for managing drilling operations or maintenance operations. For example, the well control system (144) may include one or more programmable logic controllers (PLCs) that include hardware or software with functionality to control one or more processes performed by the drilling system and/or the coring system (113). Specifically, a programmable logic controller may control valve states, fluid levels, pipe pressures, warning alarms, or pressure releases throughout a drilling rig. In particular, a programmable logic controller may be a ruggedized computer system with functionality to withstand vibrations, extreme temperatures (for example, ˜ 575° C.), wet conditions, or dusty conditions, for example, around a drilling rig. The mud circulation system may include processes and systems for circulating a drilling fluid (142) within the borehole (104). The drilling fluid (142) may include formation fluids that have seeped into the borehole during drilling and logging operations. Without loss of generality, the term “well control system” may refer to a drilling operation control system that is used to operate and control the equipment, a drilling data acquisition and monitoring system that is used to acquire drilling process and equipment data and to monitor the operation of the drilling process, or a drilling interpretation software system that is used to analyze and understand drilling events and progress.

The coring system (113) may include one or more coring tools (114), such as, but not limited to, a whole core acquisition tool (115), and/or a core plug acquisition tool (not shown). The coring tools (114) are configured to obtain one or more cores (140) such as a whole core and/or a core plug from the subsurface. A rock sample (160) may include at least a portion of the core (140) (e.g., the whole core and/or the core plug). In some embodiments, the whole core acquisition tool (115) may include a whole core storage unit (110) and the drill bit (111) disposed at a distal end of the whole core acquisition tool (115). The drill bit (111) may be a coring drill bit having a central hole. The coring drill bit is configured to drill the formation rock around a cylinder of formation rock. The whole core storage unit (110) receives the cylinder of formation rock through the central hole as the coring drill bit drills the formation rock around the cylinder of formation rock. The rock sample (160) may be formed into any shape suitable for scanning such as a cylinder, a cuboid, a sphere, a rectangular prism, and the like.

In some embodiments, the core plug acquisition tool may be configured to acquire one or more core plugs such as sidewall core plugs. The core plug acquisition tool may include one or more plug projectiles. In some embodiments, the one or more plug projectiles may be distributed equidistantly along a tool length of the core plug acquisition tools. In some embodiments, the plug projectiles may be azimuthally distributed around a longitudinal central tool axis of the core plug acquisition tool. The core plug acquisition tool may be configured to be deployed in the borehole (104) using the coring system (113). The coring system (113) may include a wireline cable and a wireline winch configured to deploy and retract the core plug acquisition tool. The wireline winch may include a wireline motor and a wireline spool with the wireline cable wrapped around the spool. The wireline winch motor is configured to rotate the wireline spool to allow more or less of the wireline cable to deploy or retract the core plug acquisition tool within the borehole (104).

For example, the core plug acquisition tool may be lowered into the borehole (104) to acquire core plugs as the core plug acquisition tool traverses the depth interval (130) (for example, a targeted reservoir formation) of the borehole (104). As the core plug acquisition tool is lowered over the depth interval (130) for a logging run, the logging tool source (not shown) may be activated at one or more activation locations (also known as firing/excitation location) (117) emitting a source signal into the borehole (104) and the subsurface (20) around the logging tool source. Each logging tool receiver (not shown) measures the source signal as the source signal radiates through the subsurface (20). In some embodiments, the core plug acquisition tool may be configured to fire the one or more plug projectiles into the borehole wall (106). The plug projectiles may be fired into the borehole wall (106) at a firing angle that is substantially perpendicular to the borehole central axis (105) and/or the borehole wall (106). The plug projectiles are configured to penetrate the borehole wall (106) and retrieve one or more cylinders of formation rock such as a core plug. The coring system (113) is configured to retrieve the core plug acquisition tool and the one or more core plugs disposed therein.

In some embodiments, a logging system (180) may be deployed with the coring system (113). In some embodiments, a logging system (180) may be deployed with the coring system (113) and configured to acquire data while drilling. In some embodiments, the logging system (180) may be deployed with the core plug acquisition tool and configured to acquire data suspended from the wireline cable in the borehole (104) while being deployed or retracted using the wireline cable and wireline winch. The logging system (180) may be configured to obtain logging measurements of the subsurface (20) using one or more logging tools (181). For example, the logging tool (181) may be lowered into the borehole (104) to acquire logging measurements as the logging tool (181) traverses the depth interval (130) (for example, targeted reservoir section) of the borehole (104). As the logging tool (181) is lowered over the depth interval (130) for a logging run, the logging tool source may be activated at one or more activation locations (117) emitting a source signal into the borehole (104) and the subsurface (20) around the logging tool source. Each logging tool receiver measures the source signal as the source signal radiates through the subsurface (20).

The one or more logging tools (181) may include, but is not limited to, a gamma-ray logging tool, a resistivity logging tool, a sonic logging tool, a porosity logging tool, a borehole imaging tool, a gas chromatography logging tool, a density logging tool, a nuclear magnetic resonance (NMR) logging tool, or combinations thereof. Each logging tool (181) is configured to obtain a corresponding well log and may be used for generating a well log data set having one or more well logs (182) of the subsurface (20).

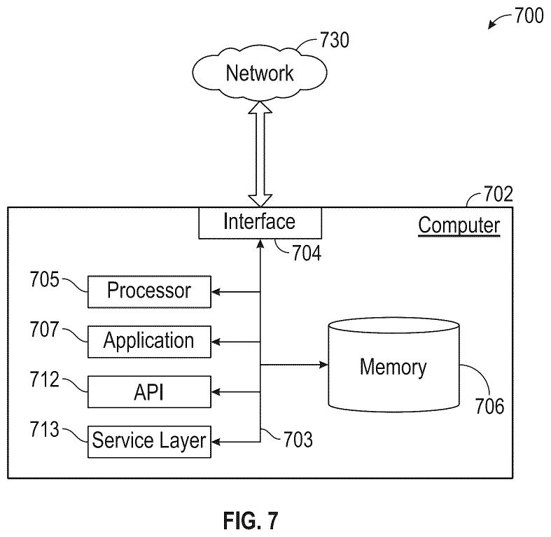

In some embodiments, the plot of the logging measurements versus depth may be referred to as a “log” or “well log.” Well logs (182) may provide depth measurements of the borehole (104) and/or may be derived from depth measurements that describe such reservoir characteristics as formation porosity, formation transit time, formation permeability, formation density, resistivity, water saturation, and the like. The well log (182) may include, for example, recorded sonic waveforms versus true vertical depth (TVD) across the depth interval (130) of the borehole (104). The resulting logging measurements may be stored or processed or both, for example, by the well control system (144), to generate corresponding well logs (182) for each logging tool (181). The logging system (180) may include a computer system that has well log processing specific software installed and may include a computer that is the same or similar to the computer (702) as described in relation to FIG. 7 and accompanying description. The logging system (180) may include logging hardware/software for controlling logging operations and for processing well logs (182).

In some embodiments, the well logs (182) may include a wide variety of noise and distortion which in their unprocessed “raw” form may not provide significant useful information about the subsurface (20). Consequently, in such embodiments the well logs (182) may be processed to remove or attenuate noise and to correctly merge distinct logging runs. For example, processing well logs (182) may include depth matching (i.e., aligning) the distinct logging runs. Depth matching includes aligning portions of the similar types of well logs from different logging runs and which overlap in depth so that the well logs are corrected for any depth errors between each logging run that may occur. Depth error may include cable stretching, tool sticking, tool slipping, and/or yo-yo effects among other issues that affect depth control of the logging tool (181). Other processing may include de-spiking. De-spiking may include removing any data point that falls outside of a given threshold. The thresholds may be input from a user on a user device. The user device may be connected wirelessly or via cable to a computer system similar or the same as the computer system (700) described in relation to FIG. 7.

In some embodiments, the rock sample (160) may be disposed in a system for aligning rock samples in a scanner (165) (hereafter “alignment system” (165)) in accordance with one or more embodiments. The alignment system (165) may include a scanner (166) and the rock sample (160). Multiple types of scanners are available for determining various reservoir characteristics, and a particular form of scanning may be selected and used based on the scanning conditions and the type of desired measurements. The scanner (166) may include a horizontal configuration where a scanner longitudinal axis of the scanner (166) is substantially horizontal. The scanner (166) is configured to scan the rock sample (160) to obtain a rock sample data set (170). The rock sample data set (170) may include one or more rock properties (23) such as density, porosity, permeability, mineralogy, and the like. In so doing, scanning data may be used alone, or in combination with the one or more well logs (182), to determine the one or more rock properties (23). In some embodiments, the one or more rock properties (23) obtained by scanning the rock sample (160) may be used to calibrate the well logs (182).

In some embodiments, the well logs (182) may be obtained to determine the one or more rock properties (23) such as porosity and permeability. For determining permeability, another type of logging may be used that is called gamma-ray (“GR”) logging. GR logging may determine the amount of gamma radiation emitted from the rock formation in the subsurface (20) by measuring the amount of gamma particles emitted from the rock formation. Porous sandstones may emit less gamma particles relative to shales. Thus, GR logs may be used to identify sandstones from shales. Likewise, density logging may also determine porosity measurements by directly measuring the density of the rocks in the subsurface (20). In addition, neutron logging may determine porosity measurements by assuming that the reservoir pore spaces within the subsurface (20) are filled with formation fluids (29) such as either formation water or oil and then measuring the amount of hydrogen atoms (that is, neutrons) in the pores. Furthermore, the logging system (180) may determine geological data for the well (101) by measuring corresponding well logs (182) for the well (101). The rock sample data set (170) may be used to calibrate the one or more well logs (182).

In some embodiments, the well environment (10) may include a well monitoring system (150). The well monitoring system (150) may include monitoring hardware/software for monitoring operations of the well site (100). Monitoring hardware may be wires, cables, hydraulic systems, pressure systems, valve systems, and measurement devices such as sensors. The well monitoring system (150) may use measurement devices that may continuously measure the conditions within the well site (100) such as pressure measurements, and/or temperature measurements. In one or more embodiments, the well monitoring system (150) may include a computer system may include a computer that is the same or similar to the computer (702) as described in relation to FIG. 7 and accompanying description. The computer (702) may include monitoring specific software configured to monitor well site operations. The measurements from the measurement devices may be transmitted to the well monitoring system (150) either wirelessly or by cable.

While FIG. 1 shows a configuration of various components of a well environment, those skilled in the art will appreciate that the various components in FIG. 1 may be combined to create a single component. Moreover, the functionality performed by a single component may be performed by two or more components. In general, a well environment may be configured in a myriad of ways. Therefore, the well environment (10) is not intended to be limiting with respect to the particular configuration of the well environment (10), well site (100) and/or well equipment.

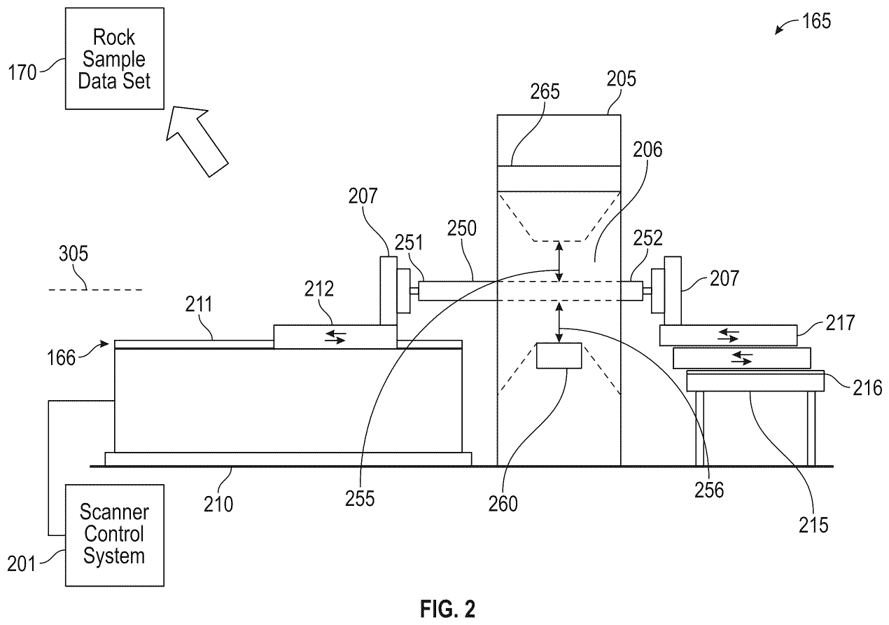

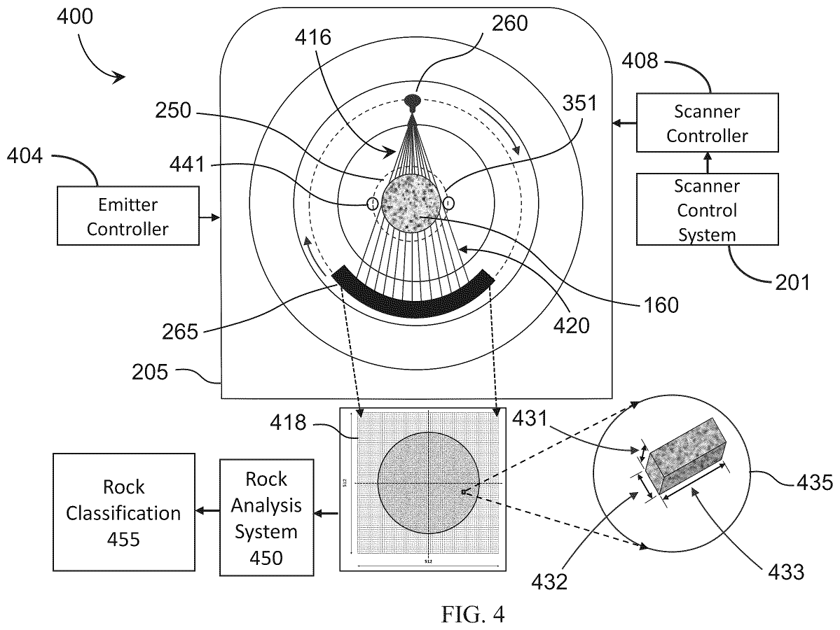

FIG. 2 depicts the alignment system (165) including the scanner (166) in accordance with one or more embodiments. The scanner (166) may include a gantry (205) having a sample scanning area (206) and a scanning system. In some embodiments, the gantry (205) may include an inner diameter defining the sample scanning area (206) in at least one planar orientation. The scanning system may be the same or similar to a scanning system (400) as described in relation to FIG. 4. The scanning system (400) includes an emitter (260) (e.g., an x-ray emitter) and a detector plate (265) (e.g., an x-ray detector plate). The detector plate (265) may be disposed within the gantry (205) opposite the emitter (260) also disposed within the gantry (205) and the sample scanning area (206) therebetween the emitter (260) and the detector plate (265). The gantry (205) is configured to encompass the sample scanning area (206) in the at least one planar orientation. It will be apparent to a person of ordinary skill in the art that the sample scanning area (206) may be of various diameters and lengths suitable for scanning purposes. The alignment system may include any scanner suitable for scanning the rock sample (160), such as a computed tomography (“CT”) scanner. The described method and system for alignment of the rock samples may be used in all medical type CT scanners, where the gantry is a closed part containing the X-ray emitter and the detectors on the other side rotating together, while the sample table is able to travel horizontally in and out of the opening of the gantry.

In some embodiments, the emitter (260) may remain stationary. The detector plate (265) may be disposed circumferentially around the inner diameter within the gantry (205). In other embodiments, the emitter (260) may rotate simultaneously with the detector plate (265) within the gantry (205) around the sample scanning area (206) to obtain the rock sample data set (170).

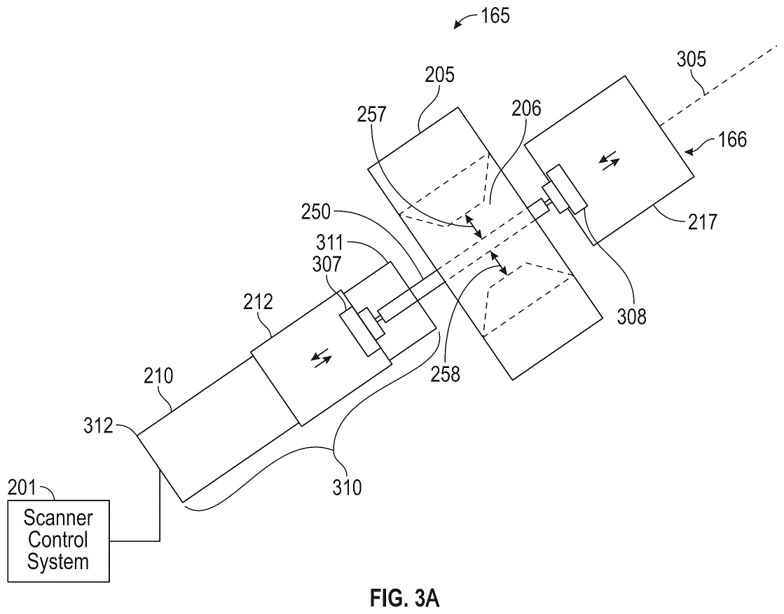

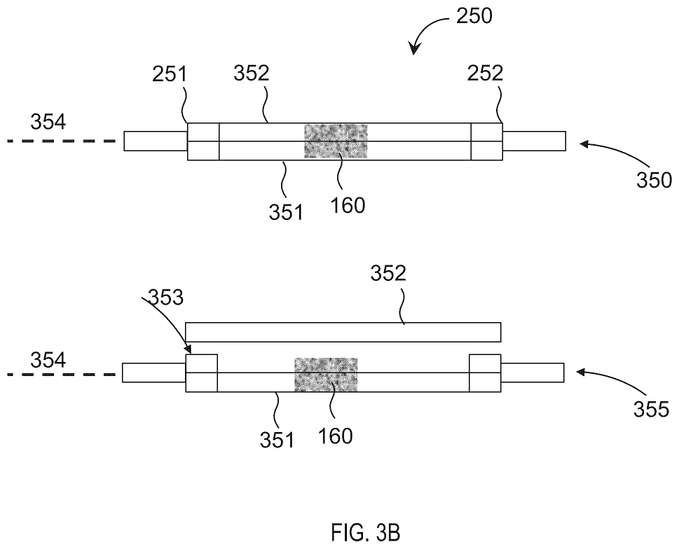

In some embodiments, the alignment system (165) includes a rock sample housing (250), such as the rock sample housing as described in relation to FIG. 3B. The rock sample housing (250) includes a first end (251), and a second end (252), and a cavity (353) and is configured to receive the rock sample (160). The cavity (353) extends from the first end (251) of the rock sample housing (250) along a housing longitudinal axis (354). The rock sample (160) includes at least a portion of the core (140). The rock sample housing (250) may be any shape suitable for receiving the rock sample (160) such as a cylinder, a cuboid, a sphere, a rectangular prism, and the like.

In some embodiments, the scanner (166) may include a clamp system (207) configured to receive the rock sample housing (250) so that at least a portion of the rock sample housing (250) extends through the sample scanning area (206). The rock sample housing (250) may be placed in the clamp system (207). In the context of this disclosure, “placed” or “placing” may refer to the rock sample housing (250) resting in the clamp system (207), being fixed to the clamp system (207), or being removably fixed to the clamp system (207). The clamp system (207) may include one or more clamp members (e.g., a first clamp member (307) and/or a second clamp member (308)) configured to secure the rock sample housing (250) within the scanner (166).

In some embodiments, the gantry (205) may receive the rock sample housing (250) and form one or more planar distances (e.g., a first planar distance (255) and a second planar distance (256)) along a planar orientation with the rock sample housing (250) therebetween. The first planar distance (255) and the second planar distance (256) may be varying distances. In some embodiments, either the first planar distance (255) or the second planar distance (256) may be negligible so the rock sample housing (250) may be in contact with the gantry (205). In some embodiments, the first planar distance (255) and the second planar distance (256) may be equidistant. In some embodiments, the planar orientation may be substantially vertical. In some embodiments, the planar orientation may be substantially horizontal.

In some embodiments, the scanner (166) may include a sliding main base (210), a sliding main rail (211), and a sliding main table (212) forming part of a translation system. The sliding main base (210) is configured to support the sliding main rail (211), the sliding main table (212) and at least part of the clamp system (207). The sliding main rail (211) may be operatively coupled to the sliding main base (210). The sliding main rail (211) may include a length of travel (310) as shown in relation to FIG. 3A. The sliding main table (212) is operatively coupled to the sliding main rail (211). The sliding main table (212) is configured to translate along the sliding main rail (211). For example, in a horizontal configuration, the sliding main table (212) is configured to translate horizontally along the length of travel (310) so as to translate the rock sample (160) horizontal within the sample scanning area (206). In some embodiments, at least part of the clamp system (207) may be operatively coupled to the sliding main table (212) such as at least one of the one or more clamp members (e.g., the first clamp member (307)) is operatively coupled to the sliding main table (212). In some embodiments, the sliding main table (212) may include one or more slabs configured to translate independently or concurrently in relation to each other so as to translate the clamp member of the clamp system (207) and the rock sample housing (250) placed in the clamp system (207). The one or more slabs of the sliding main table (212) may include at least a portion of the sliding main rail (211) so as to allow translation.

In some embodiments, the scanner (166) may include a sliding secondary base (215), a sliding secondary rail (216), and a sliding secondary table (217) also forming part of the translation system. The sliding secondary base (215) is configured to support the sliding secondary rail (216), the sliding secondary table (217), and at least part of the clamp system (207). The sliding secondary rail (216) may be operatively coupled to the sliding secondary base (215). The sliding secondary table (217) is operatively coupled to the sliding secondary rail (216). The sliding secondary table (217) is configured to translate along the sliding secondary rail (216). For example, in a horizontal configuration, the sliding secondary table (217) is configured to translate horizontally along the length of travel (310) so as to translate the rock sample (160) horizontal within the sample scanning area (206) with the sliding main table (212). In some embodiments, at least part of the clamp system (207) may be operatively coupled to the sliding secondary table (217) such as at least one of the one or more clamp members (e.g., the second clamp member (308)) is operatively coupled to the sliding secondary table (217). In some embodiments, the sliding secondary table (217) may include one or more slabs configured to translate along the length of travel (310) independently or concurrently in relation to each other so as to translate the clamp member of the clamp system (207) and the rock sample housing (250) placed in the clamp system (207). The one or more slabs of the sliding secondary table (217) may include at least a portion of the sliding secondary rail (216) so as to allow translation.

In some embodiments, the scanner (166) includes a scanner control system (201). The scanner control system (201) may include hardware or software for managing scanning operations, translation operations, and/or alignment operations. For example, the scanner control system (201) may include one or more programmable logic controllers (PLCs) (hereafter “scanner controllers”) that include hardware or software with functionality to control one or more processes performed by the scanner (166) and/or the alignment system (165) such as a scanner controller (408) as described in relation to FIG. 4. Specifically, the scanner controller (408) may control scanning system and translation system operations throughout the alignment system (165). In particular, a scanner controller may be a computer system that includes a computer that is the same or similar to the computer (702) as described in relation to FIG. 7 and accompanying description with functionality to withstand alignment operations and/or scanning operations such as emissions from the emitter (260).

In some embodiments, the scanner control system (201) is configured to translate the sliding main table (212) along the sliding main rail (211) to locate at least a portion of the rock sample housing (250) (e.g., the first end (251)) at a stopping point (e.g., a first stopping point (311)) along the length of travel (310). In some embodiments, the scanner control system (201) is configured to translate the sliding main table (212) along the sliding main rail (211) to locate at least a portion of the rock sample housing (250) (e.g., the second end (252)) at an additional stopping point (e.g., a second stopping point (312)) along the length of travel (310). Even though only two stopping points are shown in relation to FIG. 3A, it will be apparent to a person having ordinary skill in the art that there may be fewer or more stopping points along the length of travel (310) to locate one or more portions (e.g., the first end (251) and/or the second end (252)) of the rock sample housing (250) at any particular stopping point along the length of travel (310).

In some embodiments, the translation system includes table hardware for operating the sliding main table (212) and/or the sliding secondary table (217) such as motors, wires, cables, and/or belts operatively connected for translating the sliding main table (212) and/or the sliding secondary table (217). The components of the translation system as described in relation to FIG. 2 and FIG. 3 are operatively connected to the scanner control system (201).

FIG. 3A shows a top view of the alignment system (165) in accordance with one or more embodiments. The components of the alignment system (165) previously described in FIG. 2 will not be repeated in the description in relation to FIG. 3A for purposes of readability, and have the same function described above. In some embodiments, the scanner control system (201) is configured to translate the sliding main table (212), and/or the sliding secondary table (217). In some embodiments, the scanner (166) may include a scanner longitudinal axis (305). The rock sample housing (250) may be placed in the clamp system (207) so as to extend through the sample scanning area (206) along the scanner longitudinal axis (305) of the scanner (166).

A translation system may be configured in a myriad of ways, so it will be apparent to a person having ordinary skill in the art that the translation system as shown and described in relation to FIG. 2 and FIG. 3A should not be considered limiting to a particular configuration of the translation system.

In some embodiments, the gantry (205) may receive the rock sample housing (250) and form one or more additional planar distances (e.g., a third planar distance (257) and a fourth planar distance (258)) along at least one additional planar orientation with the rock sample housing (250) therebetween. The third planar distance (257) and the fourth planar distance (258) may be varying distances. In some embodiments, either the third planar distance (257) or the fourth planar distance (258) may be negligible so the rock sample housing (250) may be in contact with the gantry (205). In some embodiments, the first planar distance (255) and the second planar distance (256) may be equidistant. In some embodiments, the additional planar orientation may be substantially vertical. In some embodiments, the additional planar orientation may be substantially horizontal.

FIG. 3B shows the rock sample housing in accordance with one or more embodiments. The rock sample housing includes a body (351), a cover (352), and the cavity (353). The cavity (353) is configured to receive the rock sample (160). The cover (352) is configured to removably couple to the body (351). The rock sample may include a closed configuration (350) and an open configuration (355). The rock sample housing (250) including the body (351) and the cover (352) may be constructed from any material suitable for scanning such as any radiolucent material. For example, the rock sample housing (250) may be constructed of plexiglass. The rock sample may be disposed in the cavity (353) in the open configuration (355) and then may be scanned in the closed configuration (350).

FIG. 4 illustrates a schematic diagram of the scanning system (400) in accordance with one or more embodiments. For simplified viewing, only the gantry (205) and the scanning system (400) is shown with various other components. In some embodiments, the rock sample housing (250) may include one or more fiducial markers (441). The one or more fiducial markers (441) may be spherical and made of a radiopaque material. In the context of this disclosure, “radiopaque” means totally radiopaque or moderately radiopaque. In some embodiments, the rock sample housing (250) may include three or more fiducial markers (441) such that a three-dimensional coordinate system of the rock sample housing (250) may be defined using the fiducial markers (441).

The emitter (260) emits a source emission (416) (e.g., x-rays) towards the rock sample (160) disposed within the rock sample housing (250) placed in the clamp system (207). The source emissions (416) will pass through or mostly pass through radiolucent materials, such as the body (351) of the rock sample housing (250). Some source emissions (416) may travel to and be detected by the detector plate (265). Alternatively, some source emissions (416) will be absorbed by radiopaque materials, such as the fiducial markers (441). As such, these source emissions (416) may not travel to or be detected by the detector plate (265).

In some embodiments, the detector plate (265) may be an imaging detector such as, but not limited to, an image film, an image plate, or a flat panel detector. Further, some detector plates (265) may be digital detectors in which the detected source emissions (420) are converted into electrical signals such that an image (418) may be displayed digitally, such as on a computer system that is the same or similar to the computer system (700) as described in relation to FIG. 7 and accompanying description.

In some embodiments, the detector plate (265) may generate a “negative image” (418) where detected source emissions (420) appear black or gray and undetected source emissions appear white at specific locations on the detector plate (265). This process may be referred to as radiography and may generate a single two-dimensional projection image (418) of the rock sample (160). In these embodiments, the emitter (260) may be a radiographic device. In other embodiments, such as when the emitter (260) and the detector plate (265) rotate around the scanner longitudinal axis (305) of the scanner (166), the detector plate (265) may detect various amounts of detected source emissions (420) at different times and different positions to generate a sinogram. An inverse Radon transform may then be applied to the sinogram, using a computer system that is the same or similar to the computer system (700) as described in relation to FIG. 7 and accompanying description, to reconstruct a three-dimensional image (418) of the rock sample (160). In some embodiments, the inverse Radon transform may be applied automatically using the computer system (700). This process may be referred to as computed tomography (CT) or micro-computed tomography (μCT), if increased image resolution is desirable. In these embodiments, the scanner (166) may be a CT device or a μCT device. Hereinafter, any “image” (418) may refer to a two-dimensional projection image (418) or a three-dimensional image (418). Lastly, note that the degree of grayscale at each specific location within an image (418) may be based, at least in part, on the density of the material through which the source emissions (416) traveled. The rock sample data set (170) may include one or more images (418) from the scanning system (400) based at least in part on the rock sample (160).

In some embodiments, the image (418) may include a coordinate grid having an X-axis increment (431), a Y-axis increment (432), and a Z-axis increment (433) with each axis increment portioning each axis into equidistant increments representing a resolution of the image (418). The resolution may include a plurality of resolution elements (435) such as “pixels” for a 2D image or “voxels” for a 3D image. For example, a voxel may represent the image of a scanned volume of the rock sample (160) having an X-axis increment of 50 microns (μm), a Y-axis increment of 50 μm, and a Z-axis increment of 500 μm. The Z-axis may be aligned with a positioning central axis of the sample scanning area (206).

The alignment system (165) may include a rock analysis system (450). In some embodiments, the rock analysis system (450) may be configured to process and/or visualize the images (418). The rock analysis system (450) may include processing hardware/software for processing images. The images (418) may be stored or processed or both, for example, by the scanning system (400), to generate corresponding images for each scanning run. The scanning system (400) may include a computer system that has image processing specific software installed and may include a computer that is the same or similar to the computer (702) as described in relation to FIG. 7 and accompanying description. Typically, the image displays points of high and low reflection amplitude on a color scale or grayscale on a dense two-dimensional (“2D”) or three-dimensional (“3D)”) grid of points representing the rock sample (160). Such an image may then be interpreted, together with other information, to determine rock properties (23) and rock structure that may influence fluid flow and/or deformation (e.g., brittle, ductile and/or elastic).

It will be appreciated by a person having ordinary skill in the art that the rock sample data set (170) are extremely large, typically occupying hundreds of Gigabytes to Terabytes of data samples and cannot be manipulated or “processed” without the assistance of a purpose configured rock analysis system. Based upon the disclosure provided herein, one of ordinary skill in the art will appreciate that the gathering of the data involves specialized tools to obtain the vast quantities of gathered data, and high-speed processing capability capable of performing at least one thousand calculations per second. Indeed, in some embodiments, processors capable of millions, billions, or even more calculations per second are used. In some embodiments, processing the image (418) may include performing at least one thousand calculations per second using the rock analysis system (450).

In some embodiments, the rock analysis system (450) may include dedicated rock analysis software stored on a memory of the computer (702) to determine a rock classification (455). The rock classification (455) is based, at least in part, on the rock sample data set (170) including the images (418) based at least in part on the rock sample (160). In some embodiments, the rock classification (455) may also be based, at least in part, on the well logs (182). In some embodiments, the rock classification (455) may include one or more lithologies such as a sand lithology, a shale lithology, a carbonate lithology, or a combination thereof as representative of formations within the subsurface (20) (e.g., the reservoir formation (21)). The sand lithology, the shale lithology, and the carbonate lithology may each be formed, at least in part, from the well logs (182) used to identify the reservoir formation (21) penetrated by the borehole (104). The reservoir formation (21) may include lithologies such as sandstone rocks that have undergone compaction and diagenesis. The one or more rock samples (160) may be analyzed to identify potential minerals such as quartz, feldspar, lithics, and other various rock content as well as geologic processes that may have affected the mineral and rock content such as diagenesis, deformation, post-diagenetic processes, and the like.

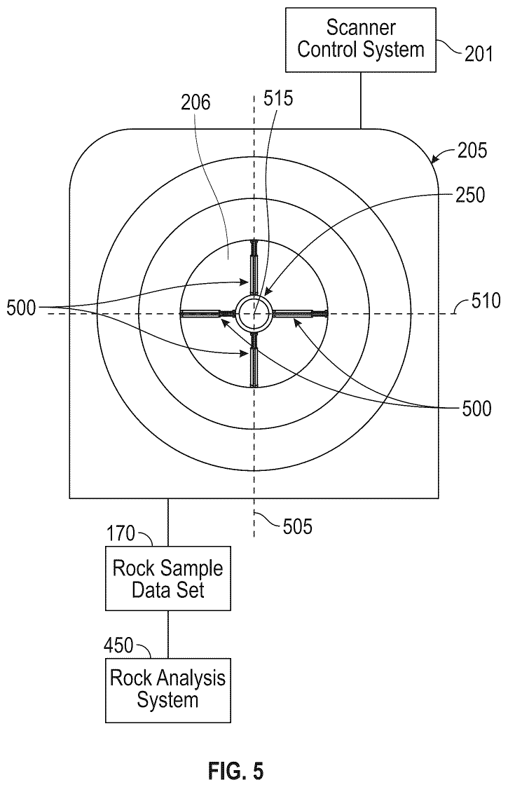

FIG. 5 shows the alignment system (165) including the gantry (205) and a plurality of alignment apparatuses (500) in accordance with one or more embodiments. For simplified viewing, only the gantry (205) and a plurality of alignment apparatuses (500) are shown. The scanner (166) includes a planar orientation (e.g., a first planar orientation (505)) and the at least one additional planar orientation (e.g., a second planar orientation (510)). In some embodiments, each planar orientation may approximately bisect the sample scanning area (206) in a particular orientation. In some embodiments, the first planar orientation (505) may be substantially perpendicular to the second planar orientation (510). In some embodiments, the planar orientation (e.g., the first planar orientation (505)) may be aligned in either a substantially vertical orientation or a substantially horizontal orientation and the additional planar orientation (e.g., the second planar orientation (510)) may be aligned in the contrasting orientation (e.g., a substantially vertical orientation or a substantially horizontal orientation) so as to be substantially perpendicular to the planar orientation. In some embodiments, the intersection of the first planar orientation (505) and the second planar orientation (510) may define a positioning central axis (515) of the sample scanning area (206). The scanner longitudinal axis (305) may be substantially parallel with the positioning central axis (515) of the sample scanning area (206).

In accordance with one or more embodiments, one of the alignment apparatuses (500) may span one of the planar distances (e.g., the first planar distance (255) or the third planar distance (257)), and another one of the alignment apparatuses (500) may span the corresponding planar distance (e.g., the second planar distance (256) or the fourth planar distance (258)) within the same planar orientation (e.g., the first planar orientation (505) or the second planar orientation (510)). Each alignment apparatus (500) may be configured to equalize the planar distance (e.g., the first planar distance (255) or the third planar distances (257)) in one particular orientation (e.g., the first planar orientation (505) or the second planar orientation (510)) and the corresponding planar distance (e.g., the second planar distance (256) or the fourth planar distance (258)) between the gantry (205) and at least a portion of the rock sample housing (250) (e.g., the first end (251) and/or the second end (252)).

In some embodiments, the alignment, using the plurality of alignment apparatuses (500), of the rock sample housing (250) may provide an improved image of the rock sample (160) relative to an image (418) of an unaligned rock sample. In some embodiments, the image (418) of an aligned rock sample may include less distortion relative to the image (418) of an unaligned rock sample.

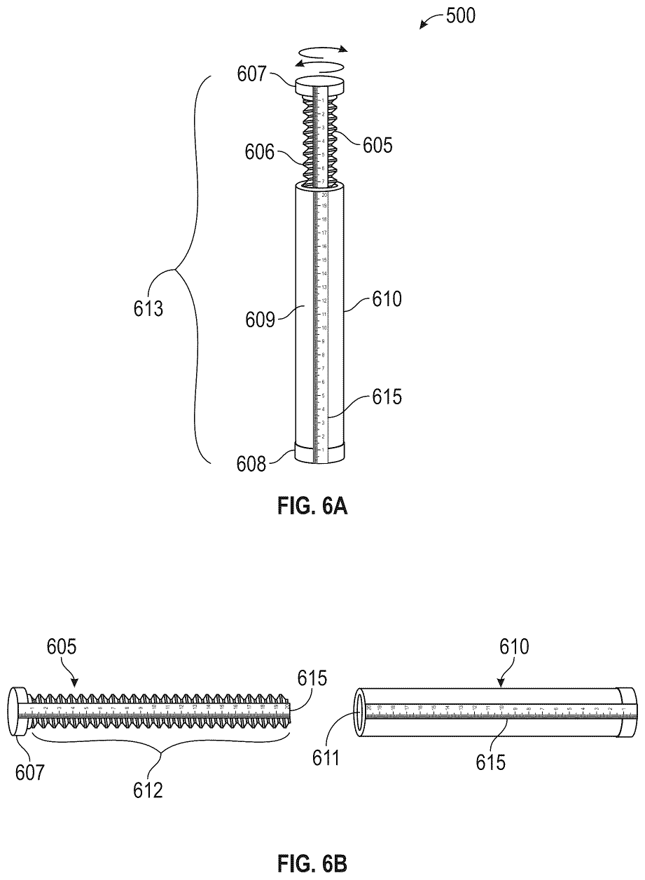

FIG. 6A shows one of the alignment apparatuses (500) in accordance with one or more embodiments. Each of the alignment apparatuses (500) is composed of two parts: an inner member (605) and an outer sleeve (610). The outer sleeve (610) is configured to operatively receive the inner member (605). The inner member (605) includes a head (607) and an outer surface (606). The head (607) is configured to removably couple to the scanner (166) (e.g., the gantry (205)) and/or the rock sample housing (250). The outer sleeve (610) may include a sleeve base (608) and a sleeve wall (609). The sleeve base (608) is configured to removably couple to the scanner (166) (e.g., the gantry (205)) and/or the rock sample housing (250).

FIG. 6B shows an exploded view of one of the alignment apparatuses (500) in accordance with one or more embodiments. The inner member (605) includes a length of extraction (612) and is configured to be extracted, at least partially, from the outer sleeve (610) so that each alignment apparatus spans the at least one of planar distances (e.g., the first planar distance (255), the second planar distance (256), the third planar distance (257), and/or the fourth planar distance (258)). The outer sleeve (610) comprises a sleeve cavity (611) configured to operatively receive the inner member (605). The outer sleeve (610) may include threads that extend into the sleeve cavity (611). The outer surface (606) of the inner member (605) may include threads configured to operatively couple with the threads of the outer sleeve (610) so the inner member (605) may be rotatably extracted and/or inserted, at least partially, in the sleeve cavity (611) along the length of extraction (612).

In some embodiments, each alignment apparatus may include an adjustable range of length (613). When the inner member (605) is fully extracted, the range of length (613) includes a maximum length. In some embodiments, the maximum length may be 400 mm. When the inner member is fully retracted, the range of length (613) includes a minimum length. In some embodiments, the minimum length may be 210 mm. It will be apparent to a person of ordinary skill in the art that the maximum and minimum lengths may also be changed depending on the size of the inner diameter of the gantry (205) and in relation to a diameter of the body (351) of the rock sample housing (250).

In some embodiments, each alignment apparatus (500) may include an integrated ruler (615). The integrated ruler (615) may include a plurality of equidistant markings representing measured distances. Each alignment apparatus (500) may be configured to equalize two or more of the planar distances (e.g., the first planar distance (255), the second planar distance (256), the third planar distance (257), the fourth planar distance (258), or combination thereof) between the gantry (205) and at least a portion of the rock sample housing (250) (e.g., the first end (251) and/or the second end (252)) along a planar orientation (e.g., the first planar orientation (505) and/or the second planar orientation (510)). In some embodiments, the plurality of alignment apparatuses (500) may be used to align the rock sample housing (250) (e.g., align along the scanner longitudinal axis (305) of the scanner (166)). The integrated ruler (615) may facilitate the equalization of the two or more planar distances.

For example, two alignment apparatuses may be configured to equalize the first planar distance (255) and the second planar distance (256) between the gantry (205) and the second end (252) of the rock sample housing (250) along the first planar orientation (505). One of the two alignment apparatuses may span the first planar distance (255) and the other one of the two alignment apparatuses may span the second planar distance (256). The first planar distance (255) and the second planar distance (256) may each be measured using the integrated ruler (615) of each of the two alignment apparatuses.

In some embodiments, for example, an additional two alignment apparatuses may be configured to equalize the third planar distance (257) and the fourth planar distance (258) along the second planar orientation (510). One of the additional two alignment apparatuses may be configured to span the third planar distance (257), and the other one of the additional two alignment apparatuses may be configured to span the fourth planar distance (258). The third planar distance (257) and the fourth planar distance (258) are each measured using the integrated ruler (615) of each of the additional two alignment apparatuses.

FIG. 7 illustrates a computer (702) in accordance with one or more embodiments. In some embodiments, the computer (702) may be a part of the scanner (166) as described in FIGS. 2-5. In these embodiments, the computer (702) may be communicably coupled to the emitter controller (404), the scanner controller (408), and/or the detector plate (265) via a network (730) either wirelessly and/or through cables/wires. In other embodiments, the computer (702) may be separate from the scanner (166). Specifically, the computer (702) may provide instructions to the emitter controller (404) and/or the scanner controller (408). Further, the computer (702) may receive information from the emitter controller (404), scanner controller (408), and/or detector plate (265). For example, the computer (702) may receive a sinogram from the detector plate (265). Received information may be used, at least in part, by the computer (702) to generate a digital image (418) of the rock sample (160).

In general, the computer (702) is intended to encompass any computing device. A computing device may include a server, desktop computer, laptop/notebook computer, wireless data port, smart phone, personal data assistant (PDA), tablet computing device, one or more processors (705) within these devices, or any other suitable processing device, including both physical and/or virtual instances. The computer (702) may include an input device, such as a keypad, keyboard, touch screen, or other device that can accept user information, such as mA and kV settings. Additionally, the computer (702) may include an output device that conveys information to a user, such as a digital image (418) of the rock sample (160).

The computer (702) can serve in a role as a client, network component, a server, a database or other persistency, or any other component (or a combination of roles). The illustrated computer (702) may be communicably coupled with a network (730) and/or other components of the scanner (166). In some implementations, one or more components of the computer (702) may be configured to operate within environments, including cloud-computing-based, local, global, or other environment (or a combination of environments).

Each of the components of the computer (702) can communicate using a system bus (703). In some implementations, any or all of the components of the computer (702), both hardware or software (or a combination of hardware and software), may interface with each other or the interface (704) (or a combination of both) over the system bus (703) using an application programming interface (API) (712) or a service layer (713) (or a combination of the API (712) and service layer (713). The API (712) may include specifications for routines, data structures, and object classes. The API (712) may be either computer-language independent or dependent and refer to a complete interface, a single function, or even a set of APIs. The service layer (713) provides software services to the computer (702) or other components (whether or not illustrated) that are communicably coupled to the computer (702). The functionality of the computer (702) may be accessible for all service consumers using this service layer. Software services, such as those provided by the service layer (713), provide reusable, defined business functionalities through a defined interface. For example, the interface may be software written in JAVA, C++, or other suitable language providing data in extensible markup language (XML) format or another suitable format. While illustrated as an integrated component of the computer (702), alternative implementations may illustrate the API (712) or the service layer (713) as stand-alone components in relation to other components of the computer (702) or other components (whether or not illustrated) that are communicably coupled to the computer (702). Moreover, any or all parts of the API (712) or the service layer (713) may be implemented as child or sub-modules of another software module, enterprise application, or hardware module without departing from the scope of this disclosure.

The computer (702) includes an interface (704). Although illustrated as a single interface (704) in FIG. 7, two or more interfaces (704) may be used according to particular needs, desires, or particular implementations of the computer (702). The interface (704) is used by the computer (702) for communicating with other systems in a distributed environment that are connected to the network (730). Generally, the interface (704) includes logic encoded in software or hardware (or a combination of software and hardware) and operable to communicate with the network (730). More specifically, the interface (704) may include software supporting one or more communication protocols associated with communications such that the network (730) or interface's hardware is operable to communicate physical signals within and outside of the illustrated computer (702).

The computer (702) includes at least one computer processor (705). Although illustrated as a single computer processor (705) in FIG. 7, two or more processors may be used according to particular needs, desires, or particular implementations of the computer (702). Generally, the computer processor (705) executes instructions and manipulates data to perform the operations of the computer (702) and any algorithms, methods, functions, processes, flows, and procedures as described in the instant disclosure. The computer processor (705) may be a central processing unit (CPU) and/or a graphics processing unit (GPU).

The computer (702) also includes a memory (706) that holds data for the computer (702) or other components (or a combination of both) that can be connected to the network (730). For example, memory (706) can be a database storing imaging data detected by the detector plate (265) of the scanner (166). Although illustrated as a single memory (706) in FIG. 7, two or more memories may be used according to particular needs, desires, or particular implementations of the computer (702) and the described functionality. While memory (706) is illustrated as an integral component of the computer (702), in alternative implementations, memory (706) can be external to the computer (702).

The application (707) is an algorithmic software engine providing functionality according to particular needs, desires, or particular implementations of the computer (702), particularly with respect to functionality described in this disclosure. For example, application (707) can serve as one or more components, modules, applications, etc. Further, although illustrated as a single application (707), the application (707) may be implemented as multiple applications (707) on the computer (702). In addition, although illustrated as integral to the computer (702), in alternative implementations, the application (707) can be external to the computer (702).

The computer system may also include an input device, such as a keypad, keyboard, touch screen, or other device that can accept user information, and an output device that displays information, including digital data, visual or audio information (or a combination of both), or a graphical user interface. The input device and the output device may be configured to interact with the interface (704).

There may be any number of computers (702) associated with, or external to, a computer system containing a computer (702), wherein each computer (702) communicates over network (730). Further, the term “client,” “user,” and other appropriate terminology may be used interchangeably as appropriate without departing from the scope of this disclosure. Moreover, this disclosure contemplates that many users may use one computer (702), or that one user may use multiple computers (702).

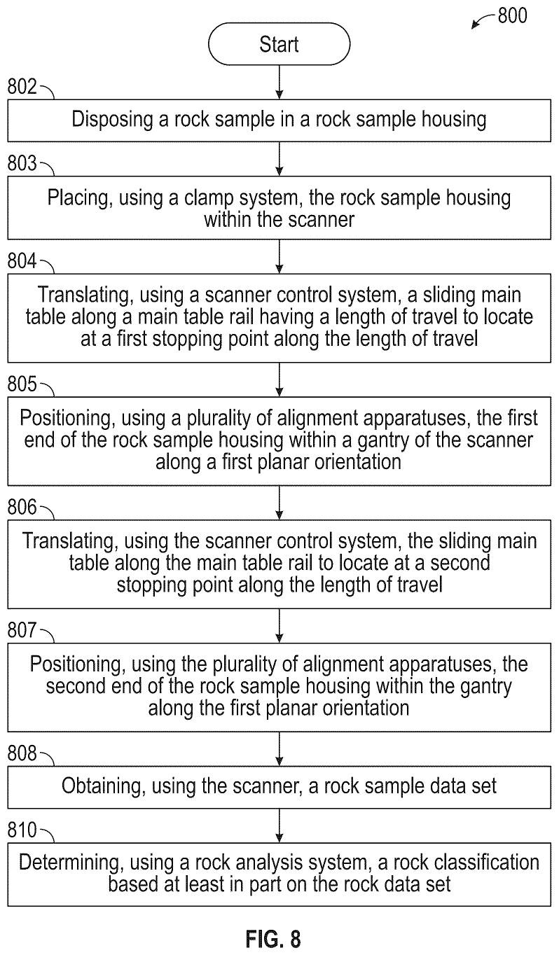

FIG. 8 depicts a flowchart in accordance with one or more embodiments describing a method for aligning rock samples in a scanner (800) (hereafter “alignment method” (800)). In some embodiments, the alignment method (800) may rely on several components of the alignment system (165). Although the steps in flowchart using the alignment method (800) are shown in sequential order, it will be apparent to one of ordinary skill in the art that some steps may be conducted in parallel, in a different order than shown, or may be omitted without departing form the scope of the invention.

In Step (802), the alignment method (800) includes disposing the rock sample (160) in the rock sample housing (250) configured to receive the rock sample (160). The rock sample (160) may be any shape suitable for being disposed within the rock sample housing (250). The rock sample housing (250) may also include spacers (not shown) disposed in the rock sample housing (250) along with the rock sample (160). The spacers may be configured to secure the rock sample (160) within the rock sample housing (250) so that any vibrations or mishandling of the rock sample housing (250) may mitigate cracks or breakage of the rock sample (160) into smaller pieces. The spacers may be constructed of any suitable spacer material that is radiolucent and suitable for reducing vibrations or mitigating any shock from dropping or otherwise mishandling of the rock sample housing (250). The spacer material may include cotton, fabric, rubber, aluminum foil, or the like. In some embodiments, the spacer material may be radiolucent wax that is poured into the rock sample housing (250) and allowed to solidify. The radiolucent wax may encapsulate at least a portion of the rock sample (160).

In Step (803), the alignment method (800) includes placing, using a clamp system (207), the rock sample housing (250) within the scanner (166) in accordance with one or more embodiments. In some embodiments, the scanner (166) includes the CT scanner. In one or more embodiments, the scanner (166) may include the horizontal configuration. In one or more embodiments, placing the rock sample housing (250) within the scanner (166) may include tightening the first clamp member (307) and the second clamp member (308) so as to removably fix the rock sample housing (250) within the scanner (166). Each clamp member (i.e., the first clamp member (307) and the second clamp member (308)) may include a fastening system (not shown) to removably fix at least a portion of the rock sample housing (250) (i.e., the first end (251) and/or the second end (252)) to either of the clamp members or both.

In Step (804), the alignment method (800) includes translating, using the scanner control system (201), the sliding main table (212) along the sliding main rail (211) to locate the first end (251) at the first stopping point (311) along the length of travel (310) in accordance with one or more embodiments. In some embodiments, the clamp system (207) is operatively connected to the sliding main table (212) and configured to translate with the sliding main table (212). In some embodiments, tightening the first clamp member (307) and the second clamp member (308) may include translating the sliding main table (212) and translating the sliding secondary table (217) so as to removably fix the rock sample housing (250) within the scanner (166).

In Step (805), the alignment method (800) involves positioning, using the plurality of alignment apparatuses (500), the first end (251) of the rock sample housing (250) within the gantry (205) of the scanner (166) along the first planar orientation (505) in accordance with one or more embodiments. In some embodiments, the alignment method (800) may include actuating the inner member (605) of each of the alignment apparatuses (500) to span the first planar distance (255) and the second planar distance (256). In some embodiments, positioning the first end (251) of the rock sample housing (250) may include loosening the clamp system (207) (i.e., the first clamp member (307) and/or the second clamp member (308)), repositioning the first end (251), and then retightening the clamp system (207) so as to removable fix the rock sample housing (250) within the scanner (166).

In Step (806), the alignment method (800) may include translating, using the scanner control system (201), the sliding main table (212) along the sliding main rail (211) to locate the second end (252) at the second stopping point (312) along the length of travel (310) in accordance with one or more embodiments. In some embodiments, the alignment method (800) may include translating, using the scanner control system (201), the sliding secondary table (217) of the scanner (166) automatically with the sliding main table (212).

In Step (807), the alignment method (800) may include positioning, using the plurality of alignment apparatuses (500), the second end (252) of the rock sample housing (250) within the gantry (205) along the first planar orientation (505) in accordance with one or more embodiments. In some embodiments, positioning the second end (252) of the rock sample housing (250) may include loosening the clamp system (207) (i.e., the first clamp member (307) and/or the second clamp member (308)), repositioning the second end (252), and then retightening the clamp system (207) so as to removable fix the rock sample housing (250) within the scanner (166).

In accordance with one or more embodiments, the alignment method (800) may include equalizing, using the plurality of alignment apparatuses (500), the first planar distance (255) and the second planar distance (256) between the gantry (205) and the first end (251) of the rock sample housing (250) along the first planar orientation (505). One of the alignment apparatuses (500) may span the first planar distance (255) and another one of the alignment apparatuses (500) may span the second planar distance (256). The first planar distance (255) and the second planar distance (256) may each be measured using the integrated ruler (615) of each alignment apparatus (500). In the context of this disclosure, equalizing means to be exactly equal or to be approximately equal within about 1% margin of tolerance.

In accordance with one or more embodiments, the alignment method (800) may include equalizing, using the plurality of alignment apparatuses (500), the first planar distance (255) and the second planar distance (256) between the gantry (205) and the second end (252) of the rock sample housing (250) along the first planar orientation (505). One of the alignment apparatuses (500) may span the first planar distance (255) and another one of the alignment apparatuses (500) span the second planar distance (256). The first planar distance (255) and the second planar distance (256) may each be measured using the integrated ruler (615) of each alignment apparatus (500).

In accordance with one or more embodiments, positioning the rock sample housing (250) along the first planar orientation (505) may include positioning the rock sample housing (250) along a vertical planar orientation. In some embodiments, positioning the rock sample housing (250) along the second planar orientation (510) may include positioning the rock sample housing (250) along a horizontal planar orientation.

In accordance with one or more embodiments, the alignment method (800) may include positioning the rock sample housing (250) along both the first planar orientation (505) and the second planar orientation (510). In some embodiments, positioning the rock sample housing (250) along both the first planar orientation (505) and the second planar orientation (510) may include positioning the rock sample housing (250) along both the vertical planar orientation and the horizontal planar orientation so that the housing longitudinal axis (354) is substantially aligned with the positioning central axis (515) of the sample scanning area (206).

In accordance with one or more embodiments, the alignment method (800) may include equalizing, using the plurality of alignment apparatuses (500), the third planar distance (257) and the fourth planar distance (258) between the gantry (205) and the first end (251) of the rock sample housing (250) along the second planar orientation (510). One of the alignment apparatuses (500) span the third planar distance (257) and another one of the alignment apparatuses (500) span the fourth planar distance (258). The third planar distance (257) and the fourth planar distance (258) may each be measured using the integrated ruler (615) of the plurality of alignment apparatuses (500).

In accordance with one or more embodiments, the alignment method (800) may include equalizing, using the plurality of alignment apparatuses (500), the third planar distance (257) and the fourth planar distance (258) between the gantry (205) and the second end (252) of the rock sample housing (250) along the second planar orientation (510). One of the alignment apparatuses (500) span the third planar distance (257) and another one of the alignment apparatuses (500) span the fourth planar distance (258). The third planar distance (257) and the fourth planar distance (258) may each be measured using the integrated ruler (615) of the plurality of alignment apparatuses (500).

In Step (808), the alignment method (800) involves obtaining, using the scanner (166), the rock sample data set (170), in accordance with one or more embodiments. The rock sample (160) is scanned using the scanning system (400). The rock sample housing is translated along the scanner longitudinal axis (305) using the translation system as described in relation to FIG. 2 and FIG. 3A. In Step (810), the alignment method (800) includes determining, using the rock analysis system (450), the rock classification (455) based at least in part on the rock sample data set (170) as described in relation to FIG. 4, in accordance with one or more embodiments.

Embodiments of the present disclosure may provide at least one of the following advantages. The alignment system and method may relatively improve the rock sample data set including the image (418) after alignment of the rock sample housing (250) within the scanner (166) then if the rock sample housing is scanned without alignment. The alignment system and method provide increased efficiency in scanning by eliminating repeated scans to calibrate manual alignment of the rock sample housing (250). The improved data includes less distortion of the image (418). The range of length capability of the alignment apparatus enables the method to be used for the whole range of different sizes of rock sample housings, which may include ranges from 50 mm to 180 mm in diameter for rock samples from 1.0 inch to 4.0 inches, respectively.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A method for aligning rock samples in a scanner, comprising:
disposing a rock sample in a rock sample housing configured to receive the rock sample,
wherein the rock sample housing comprises a first end and a second end;
placing, using a clamp system, the rock sample housing within the scanner,
translating, using a scanner control system, a sliding main table along a sliding main rail having a length of travel to locate the first end at a first stopping point along the length of travel,
wherein the clamp system is operatively connected to the sliding main table and configured to translate with the sliding main table;
positioning, using a plurality of alignment apparatuses, the first end of the rock sample housing within a gantry of the scanner along a first planar orientation;
translating, using the scanner control system, the sliding main table along the sliding main rail to locate the second end at a second stopping point along the length of travel; and
positioning, using the plurality of alignment apparatuses, the second end of the rock sample housing within the gantry along the first planar orientation.

2. The method of claim 1,
wherein each of the plurality of alignment apparatuses comprises an integrated ruler;
the method further comprising:
equalizing, using the plurality of alignment apparatuses, a first planar distance and a second planar distance between the gantry and the first end of the rock sample housing along the first planar orientation,
wherein one of the plurality of alignment apparatuses span the first planar distance and another one of the plurality of alignment apparatuses span the second planar distance,
wherein the first planar distance and the second planar distance are each measured using the integrated ruler of one of the plurality of alignment apparatuses.

3. The method of claim 2 further comprising:
equalizing, using the plurality of alignment apparatuses, the first planar distance and the second planar distance between the gantry and the second end of the rock sample housing along the first planar orientation,
wherein one of the plurality of alignment apparatuses span the first planar distance and another one of the plurality of alignment apparatuses span the second planar distance,
wherein the first planar distance and the second planar distance are each measured using the integrated ruler of one of the plurality of alignment apparatuses.

4. The method of claim 3,
wherein the first planar orientation comprises a vertical planar orientation.

5. The method of claim 1,
wherein each of the plurality of alignment apparatuses comprises an integrated ruler;
the method further comprises:
equalizing, using the plurality of alignment apparatuses, a third planar distance and a fourth planar distance between the gantry and the first end of the rock sample housing along a second planar orientation,
wherein one of the plurality of alignment apparatuses span the third planar distance and another one of the plurality of alignment apparatuses span the fourth planar distance,
wherein the third planar distance and the fourth planar distance are each measured using the integrated ruler of one of the plurality of alignment apparatuses.

6. The method of claim 5,
wherein the second planar orientation comprises a horizontal planar orientation.

7. The method of claim 2,
wherein each of the plurality of alignment apparatuses comprises an inner member and an outer sleeve;
the method further comprising:
actuating the inner member of each of the plurality of alignment apparatuses to span the first planar distance and the second planar distance.

8. The method of claim 1, further comprising:
translating, using the scanner control system, a sliding secondary table of the scanner automatically with the sliding main table.

9. The method of claim 1, wherein the scanner comprises a computed tomography (“CT”) scanner.

10. The method of claim 1, further comprises:
obtaining, using the scanner, a rock sample data set; and
determining, using a rock analysis system, a rock classification based at least in part on the rock sample data set.

11. A system for aligning rock samples in a scanner, comprising:
a rock sample;
a rock sample housing configured to receive the rock sample and comprising a first end and a second end,
a scanner comprising:
a gantry configured to scan the rock sample,
a sliding main rail having a length of travel,
a sliding main table configured to:
translate along the sliding main rail, and
a clamp system operatively connected to the sliding main table, wherein the clamp system is configured to receive the rock sample housing;
a plurality of alignment apparatuses configured to:
position the first end of the rock sample housing within the gantry along a first planar orientation, and
position the second end of the rock sample housing within the gantry along the first planar orientation; and
a scanner control system configured to:
translate the sliding main table along the sliding main rail to locate the first end at a first stopping point along the length of travel, and
translate the sliding main table along the sliding main rail to locate the second end at a second stopping point along the length of travel.

12. The system of claim 11,
wherein each of the plurality of alignment apparatuses comprises an integrated ruler,
the plurality of alignment apparatuses configured to:
equalize a first planar distance and a second planar distance between the gantry and the first end of the rock sample housing along the first planar orientation,
wherein one of the plurality of alignment apparatuses span the first planar distance and another one of the plurality of alignment apparatuses span the second planar distance,
wherein the first planar distance and the second planar distance are each measured using the integrated ruler of one of the plurality of alignment apparatuses.

13. The system of claim 12,
the plurality of alignment apparatuses is further configured to:
equalize the first planar distance and the second planar distance between the gantry and the second end of the rock sample housing along the first planar orientation,
wherein one of the plurality of alignment apparatuses span the first planar distance and another one of the plurality of alignment apparatuses span the second planar distance,
wherein the first planar distance and the second planar distance are each measured using the integrated ruler of one of the plurality of alignment apparatuses.

14. The system of claim 13,
wherein the first planar orientation comprises a vertical planar orientation.

15. The system of claim 11,
wherein each of the plurality of alignment apparatuses comprises an integrated ruler,
the plurality of alignment apparatuses configured to:
equalize a third planar distance and a fourth planar distance between the gantry and the first end of the rock sample housing along a second planar orientation;
wherein one of the plurality of alignment apparatuses span the third planar distance and another one of the plurality of alignment apparatuses span the fourth planar distance,
wherein the third planar distance and the fourth planar distance are each measured using the integrated ruler of one of the plurality of alignment apparatuses.

16. The system of claim 15,
wherein the second planar orientation comprises a horizontal planar orientation.

17. The system of claim 12,
wherein each of the plurality of alignment apparatuses comprises an inner member and an outer sleeve; and
each inner member of the plurality of alignment apparatuses are configured to span the first planar distance and the second planar distance.

18. The system of claim 11, wherein the scanner control system is configured to translate a sliding secondary table of the scanner automatically with the sliding main table.

19. The system of claim 11, wherein the scanner comprises a computed tomography (“CT”) scanner.

20. The system of claim 11, further comprises:
the scanner is configured to obtain a rock sample data set; and
a rock analysis system is configured to determine a rock classification based at least in part on the rock sample data set.
